(19) United States
(12) Patent Application Publication
(10) Pub. No.: US 2009/0238139 A1
(43) Pub. Date: Sep. 24, 2009

(54) Apparatus and Method for Providing Service for Media Independent Handover

(76) Inventors: Eun-Ah Kim, Daejeon (KR); Jong-Hwa Yi, Daejeon (KR); Jung-Hoon Jee, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/084,823

(22) PCT Filed: Mar. 14, 2006
(86) PCT No.: PCT/KR2006/000912

§ 371 Date: May 9, 2008

(30) Foreign Application Priority Data
Nov. 11, 2005 (KR) 10-2005-0107954

(51) Int. Cl. H04W 36/00

(52) U.S. Cl. 370/331

(57) ABSTRACT

A service providing method and apparatus provides a service for a media independent handover (MIH). A first node receives a first message from a second node, the first message including information about whether the second node supports a service through first layer and whether the second node supports a service through second layer, and the first node selects a service transport layer for providing a service from the first and second layers and provides a service to the second node through the service transport layer. Accordingly, the first node may effectively perform an MIH because it may easily understand the MIH capability of the second node.

### BACKGROUND OF THE INVENTION

(a) Field of the Invention

The present invention relates to a service providing method and apparatus for a media independent handover.

(b) Description of the Related Art

A media independent handover (MIH) standardized by the Institute of Electrical and Electronics Engineers (IEEE) 802.21 group is a technology for providing a seamless handover of a terminal to accept various application service supports where the terminal has a multi wireless interface such as an IEEE 802.11-based wireless local area network (WLAN), IEEE 802.16-based wibro, a wideband code division multiple access (WCDMA), and wideband code division multiple access 2000 (CDMA-2000) to frequently visit each different media. The media independent handover is realized by exchanging handover information through event, command, and information services between the terminal and base station.

FIG. 1 illustrates a network for supporting a conventional media independent handover.

As shown in FIG. 1, a terminal (TE) 1 accepts a data service by communicating with an access point (AP) 2 in an IEEE 802.11-based wireless local area network (WLAN). The terminal 1 moves to an IEEE 802.16-based portable Internet area and performs a handover from the wireless local area network (WLAN) to the portable Internet.

In order to achieve a handover between each different media, the terminal 1 must have an IEEE 802.11 wireless interface and an IEEE 802.16 wireless interface, and the AP 2 and a radio access station (RAS) 3 must support media independent handover, that is, a handover between heterogeneous networks.

Accordingly, the terminal 1 determines whether the AP 2 and RAS 3 additionally support the MIH and performs a handover when the AP 2 and RAS 3 also support the MIH.

The terminal 1 may determine whether the AP 2 and RAS 3 additionally support the MIH using capability information included in a message periodically broadcast by the AP 2 or RAS 3. In addition, the terminal 1 may also determine whether the AP 2 and RAS 3 support the MIH by transmitting a request message for inquiring whether the AP 2 and RAS 3 support the MIH and receiving a response message thereto. Meanwhile, the AP 2 or RAS 3 must also determine whether the terminal 1 supports the MIH. As such, it is referred to as “MIH capability discovery” when the terminal 1, AP 2, or RAS 3 discovers whether a correspondence node supports the MIH.

In the IEEE 802.21 group, various MIH capability discovery methods have been proposed.

FIG. 2 illustrates a beacon frame capability information fixed field.

According to the IEEE 802.11 standard, the AP 2 of the wireless local area network (WLAN) broadcasts a beacon frame. The IEEE 802.21 group has proposed that the AP 2 may provide MIH capability information to the terminal when a part of the beacon frame is corrected. For example, the last bit of a reserved area is defined as an ‘Extend Capability Field’. Accordingly, when the bit is given as 1, the extend capability information element is included in the beacon frame as shown in FIG. 3.

FIG. 3 illustrates an extend capabilities field of extended capability information element included in a beacon frame, including MIH capability information.

The “extend capabilities field” shown in FIG. 3 is a field added to the beacon frame when the last bit of “capability information fixed field” shown in FIG. 2 is given as 1. As shown in FIG. 3, a 0-th bit is defined as MIH capability information. That is, when the terminal receives the beacon frame from the AP, the terminal may determine whether the AP supports the MIH.

However, in order for the terminal to support a media independent handover, it must include protocol stacks of a plurality of media. In addition, in order for the terminal to support a media independent handover, it must exchange event, command, and neighbor network information with the base station. However, since each wireless interface has a different protocol stack, it is difficult to determine how to transport these information to the base station.

In addition, in the case of the MIH capability discovery method using broadcasting, the terminal may determine the MIH capability of the base station. However, the base station cannot determine the MIH capability of the terminal.

In addition, in the case of the MIH capability discovery method using message exchange, the terminal and the base station must repeatedly do the message exchange at least twice so as to discover each other's MIH capability. Accordingly, much time is consumed and complex processes must be performed so as to determine MIH capability.

FIG. 4 illustrates a MIH_Capability_IE that is newly defined by the IEEE 802.21 such that the IEEE 802.16-based downlink map (DL-MAP) message includes the added MIH capability information, and FIG. 5 illustrates an IEEE 802.16-based MOB_NBR_ADV_Message_Format proposed by IEEE 802.21 so as to include the MIH capability information.

As shown in FIG. 4 and FIG. 5, conventionally, since each message includes only the MIH capability information as 1 bit, the above-noted problems still exist.

### SUMMARY OF THE INVENTION

The present invention has been made in an effort to provide a service providing method and apparatus having advantages of effectively performing a wireless-accessed media independent handover.

An exemplary embodiment of the present invention provides a service providing method for a first node providing a service to a second node. The service providing method includes receiving a first message from the second node, the first message including information about whether the second node supports a service through a first layer and whether the second node supports a service through a second layer;

selecting a service transport layer for providing a service from the first and second layers; and

providing a service to the second node through the service transport layer.

Another embodiment of the present invention provides a service providing method for a first node providing a service to a second node. The service providing method includes receiving a first message from the second node, the first message including first, second, and third information respectively concerning whether the second node supports a command service, whether the second node supports an event service, and an information service;

providing a command to the second node when the second node supports the command service;

providing an event to the second node when the second node supports the event service, the event being state variance information of the first node; and

providing the information service to the second node when the second node supports the information service.

Yet another embodiment of the present invention provides a service providing apparatus for providing a service to a first node. The service providing apparatus includes a wireless interface for providing a wireless data service by including at least one of wireless interface;

an application unit for using the wireless data service;

a message transmitting/receiving unit for receiving a first message from the first node, the first message including first, second, and third information respectively concerning whether the first node supports a command service, whether the first node supports an event service, and whether the first node supports an information service;

a command service processing unit for providing the command of the application unit to the first node when the first node supports the command service;

an event service processing unit for providing the event to the first node when the first node supports the event service, the event regarding state variance information of the wireless interface; and

an information service processing unit for providing network information to the first node in response to a network information request from the first node when the first node supports the information service.

### BRIEF DESCRIPTION OF THE DRAWINGS

FIG. 1 illustrates a network for supporting a conventional media independent handover.

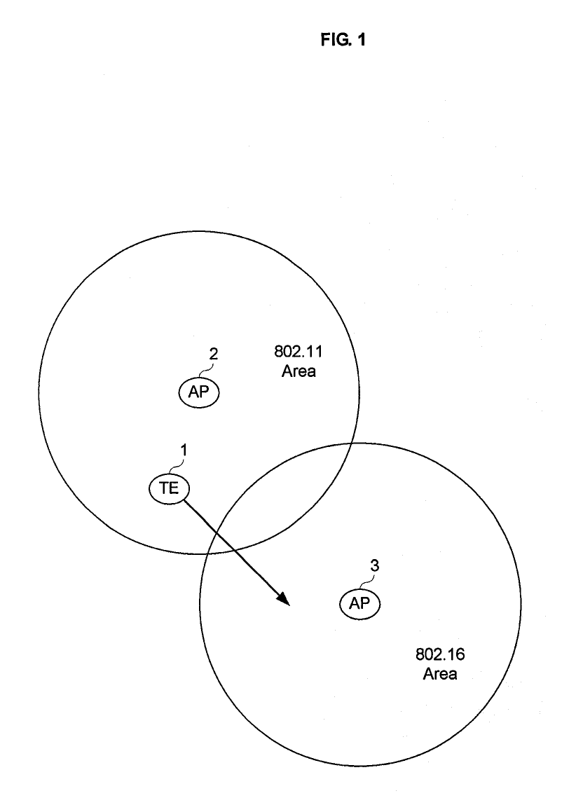

FIG. 2 illustrates a capability information fixed field of a beacon frame.

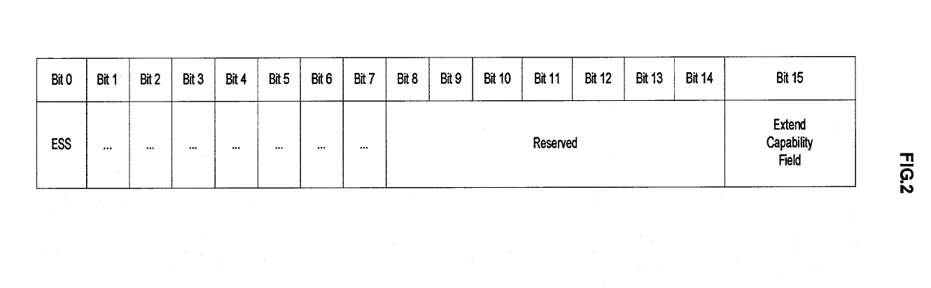

FIG. 3 illustrates an extend capabilities field of extended capability information element of a beacon frame including MIH capability information.

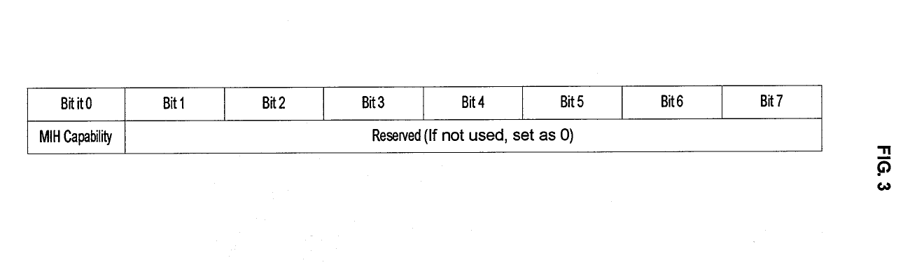

FIG. 4 illustrates an MIH_Capability_IE newly defined by the IEEE 802.21 such that IEEE 802.16-based downlink map (DL-MAP) message includes added MIH capability information.

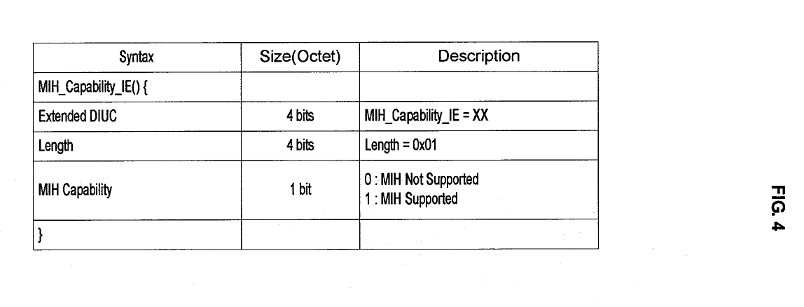

FIG. 5 illustrates an IEEE 802.16-based MOB_NBR_ADV_Message_Format proposed by IEEE 802.21 so as to include the MIH capability information.

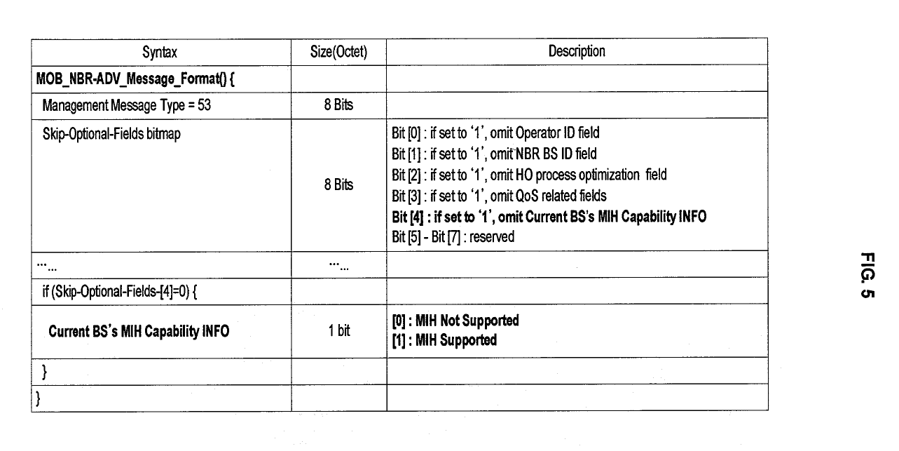

FIG. 6 illustrates a terminal according to an exemplary embodiment of the present invention.

FIG. 7 is a block diagram for showing an IEEE 802.11-based AP according to an exemplary embodiment of the present invention.

FIG. 8 is a block diagram for showing an IEEE 802.16-based RAS according to an exemplary embodiment of the present invention.

FIG. 9 is a block diagram of a WCDMA-based node B according to an exemplary embodiment of the present invention.

FIG. 10 is a block diagram of an MIH controller according to an exemplary embodiment of the present invention.

FIG. 11 illustrates MIH capability discover message according to an exemplary embodiment of the present invention.

FIG. 12 illustrates a frame format of an MIH capability discover message according to an exemplary embodiment of the present invention.

FIG. 13 is a flowchart for exchanging an event service between first and second nodes according to an exemplary embodiment of the present invention.

FIG. 14 is a flowchart for exchanging a command service between first and second nodes according to an exemplary embodiment of the present invention.

FIG. 15 is a flowchart for exchanging an information service between first and second nodes according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprising” or variations such as “comprises” will be understood to imply the inclusion of stated elements but not the exclusion of any other elements.

Hereinafter, a terminal, a wireless local area network (WLAN) based access point, a wibro-based radio access station (RAS), a WCDMA-based node B, a CDMA2000-based base transceiver station (BTS), etc., are generally referred to as a node.

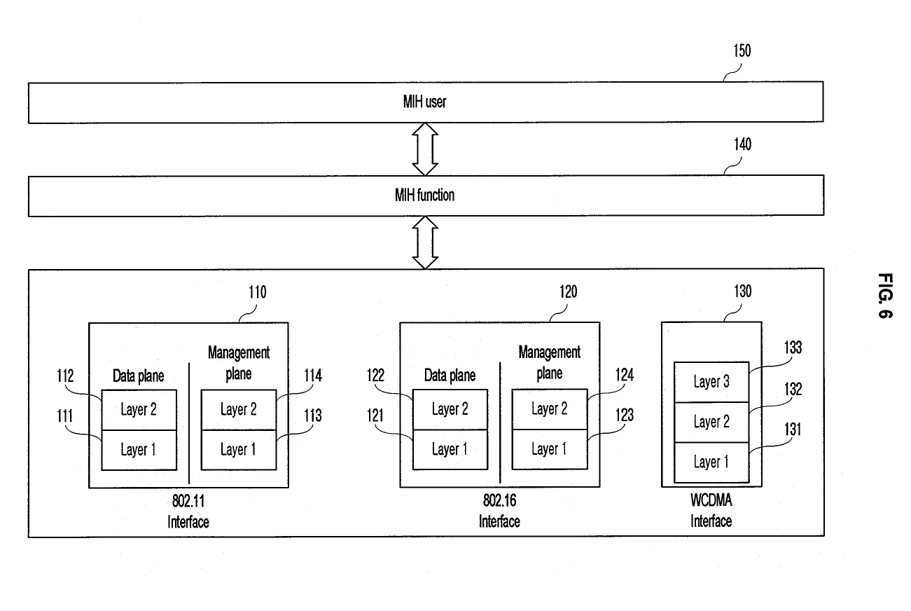

A media independent handover according to an exemplary embodiment of the present invention is described with reference to FIG. 6 to FIG. 9.

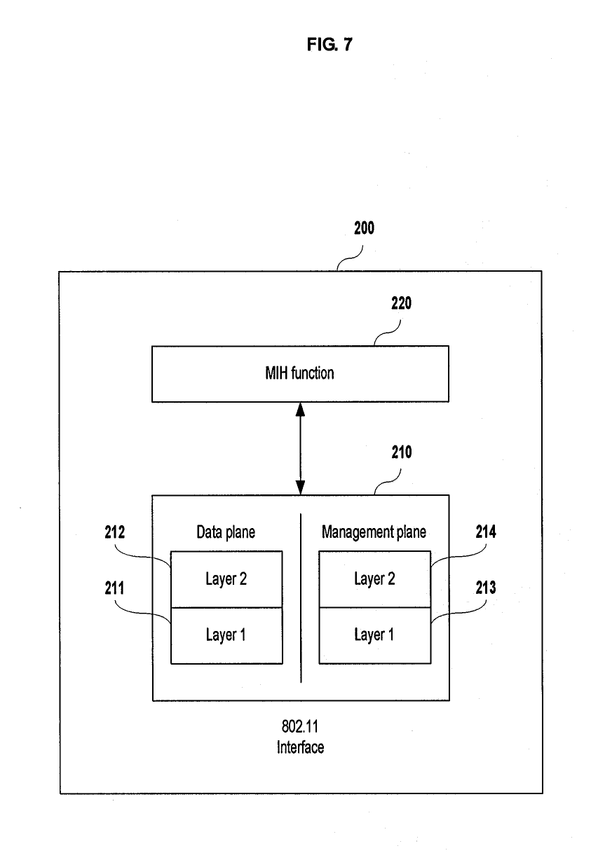

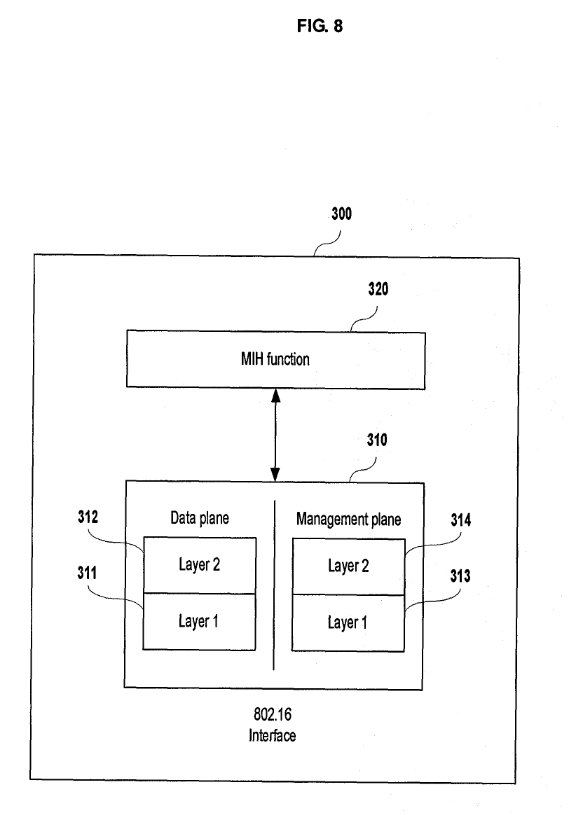

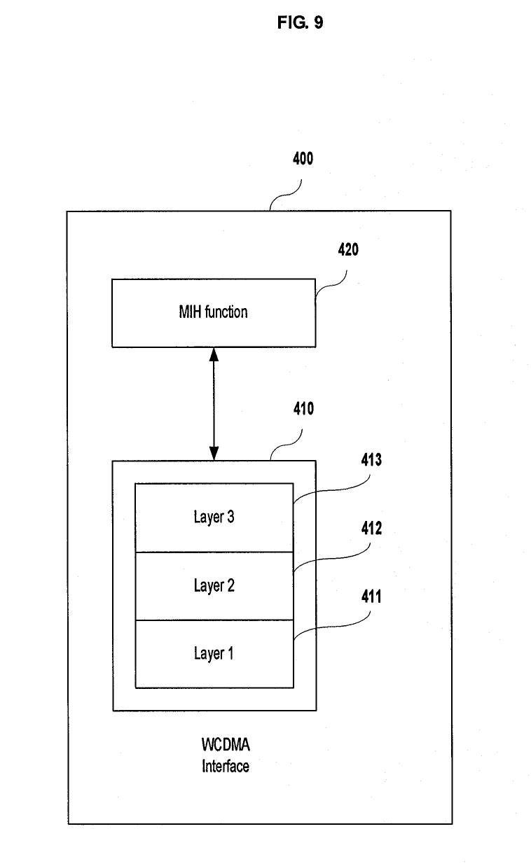

FIG. 6 illustrates a terminal according to an exemplary embodiment of the present invention. As shown in FIG. 6, the terminal 100 includes an 802.11 interface 110, an 802.16 interface 120, a WCDMA interface 130, an MIH function 140, and an MIH user 150. The 802.11 interface 110 communicates with the 802.11 interface 210 (see FIG. 7) of the AP 200 (see FIG. 7) and includes layers 1 and 2 111 and 112 at a data plane and layers 1 and 2 113 and 114 at a management plane. The 802.16 interface 120 communicates with the 802.16 interface 310 (see FIG. 8) of the RAS 300 (see FIG. 8) and includes layers 1 and 2 121 and 122 at a data plane and layers 1 and 2 123 and 124 at a management plane. And the WCDMA interface 130 communicates with a WCDMA interface 410 (see FIG. 9) of a node B 400 (see FIG. 9) and includes layers 1, 2 and 3 131, 132 and 133.

FIG. 7 is a block diagram for showing an IEEE 802.11-based AP according to an exemplary embodiment of the present invention. As shown in FIG. 7, the AP 200 includes an 802.11 interface 210 and an MIH function 220, and the 802.11 interface 210 includes layers 1 and 2 211 and 212 at a data plane and layers 1 and 2 213 and 214 at a management plane.

FIG. 8 is a block diagram for showing an IEEE 802.16-based RAS according to an exemplary embodiment of the present invention. As shown in FIG. 8, the RAS 300 includes an 802.16 interface 310 and an MIH function 320, and the 802.16 interface 310 includes layers 1 and 2 311 and 312 at a data plane and layers 1 and 2 313 and 314 at a management plane.

FIG. 9 is a block diagram of a WCDMA-based node B according to an exemplary embodiment of the present invention. As shown in FIG. 9, the node B 400 includes a WCDMA interface 410 and an MIH function 420, and the WCDMA interface 410 includes layers 1, 2 and 3 411, 412 and 413.

The layer 1 111, the layer 1 113, the layer 1 121, the layer 1 123, and the layer 1 131 of the terminal 100 are expressed as physical layers and respectively exchange data through the same protocol with the layer 1 211 of the AP 200, the layer 1 213 of the AP 200, the layer 1 311 of the RAS 300, the layer 1 313 of the RAS 300, and the layer 1 411 of the node B. For example, the layer 1 111 performs coding and modulation to the data from the upper layer 2 112 and transmits the coded and modulated data to the layer 1 211 of the AP 200, and performs demodulation and decoding to a signal from the layer 1 211 of the AP 200 and transmits the same to the layer 2 112.

Meanwhile, the layer 2 112, the layer 2 114, the layer 2 122, the layer 2 124, and the layer 2 132 of the terminal 100 are expressed as data link layers or media access control layers (MAC layers), and respectively exchange data through the same protocol with the layers 2 212, 214, 312, 314, and 412. The layers 2 112, 114, 122, 124, and 132 control access to a medium shared by a plurality of nodes.

The 802.11 and 802.16 interfaces of the terminal 100 are respectively divided into the data plane and the management plane, and include a physical layer and a MAC layer. The data plane is used for transmitting/receiving user data and the management plane is for transmitting/receiving control data.

The layer 3 133 of the WCDMA interface 130 of the terminal 100 is an upper layer of the layer 2 132, and may be a network layer that is capable of assigning a packet path. The layer 3 133 exchanges data through the same protocol as the layer 3 413 of the node B 400.

The MIH using unit 150 accepts consecutive data service through a plurality of wireless interfaces, for example 802.11 interface 110, 802.16 interface 120, and WCDMA interface 130.

The MIH function 140 of the terminal provides an interface between a plurality of wireless interfaces and the MIH user 150 and performs MIH function message transmission and handover control, etc.

In order for the media independent handover according to an exemplary embodiment of the present invention to occur, it is assumed that the terminal 100 performs a handover from the IEEE 802.16-based portable Internet to the WCDMA-based area. At this time, the terminal 100 moves to the WCDMA area after it accesses through the 802.16 interface 120 to the 802.16 interface 310 of the RAS 300 and accepts a packet service, and then it accesses through the WCDMA interface 130 to the WCDMA interface 410 of the node B 400, accepts a packet service, and finishes the 802.16 interface 310 access.

In order to perform such a media independent handover, each of the MIH function 140, 220, 320, and 420 of the terminal 100, the AP 200, the RAS 300, and the node B 400 must exchange event, command, and network information with each other. It is defined as an event service that one node provides or accepts event such as its state variance to or from the other node Similarily, command service is that one node provides command for controlling the other node or accepts command from the other node and performs it. Information service is that one node receiving information request from the other node provides the requested information such as neighbor network information or accepts the requested information offered by the other node when it receives information request.

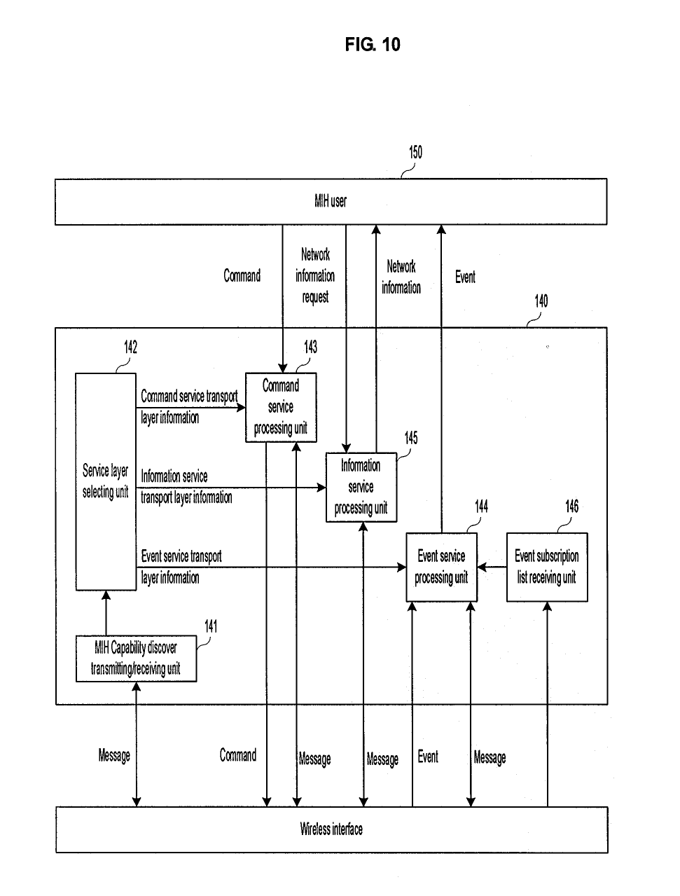

However, since each node has a different protocol for each wireless access, it is difficult to know which protocol other nodes support so as to provide the above various services. The MIH function 140 for solving such a problem according an exemplary embodiment of the present invention is described with reference to FIG. 10. The MIH function 140 of FIG. 10 may be applied to other nodes as well as the terminal 100.

FIG. 10 is a block diagram of an MIH function according to an exemplary embodiment of the present invention.

As shown in FIG. 10, according to an exemplary embodiment of the present invention, the MIH function 140 includes an MIH capability discover message transmitting/receiving unit 141, a service layer selection unit 142, a command service processing unit 143, an event service processing unit 144, an information service processing unit 145, and an event subscription list receiving unit 146.

In order to describe the MIH function 140 according to an exemplary embodiment of the present invention, it is assumed that the terminal 100 is accessing the RAS 300.

The MIH capability discover message transmitting/receiving unit 141 transmits an MIH capability discover request message to the RAS 300 and receives an MIH capability discover response message from the RAS 300 in response to the same. In addition, the MIH capability discover message transmitting/receiving unit 141 receives an MIH capability discover request message from the RAS 300 and transmits an MIH capability discover response message to the RAS 300 in response to the same. Hereinafter, the MIH capability discover response message and the MIH capability discover request message are together referred to as an MIH capability discover message. The MIH capability discover message transmitting/receiving unit 141 may receive the broadcasted MIH capability discover message.

Next, it is described that the terminal 100 transmits an MIH capability discover request message to the RAS 300 and receives an MIH capability discover response message from the RAS 300 in response to the same.

The MIH capability discover response message may be a response to the MIH capability discover request message, and may be a message broadcast from the RAS 300.

The MIH capability discover response message may include whether the RAS 300 supports an event service, whether the RAS 300 supports a command service, and whether the RAS 300 supports an information service. Since the terminal 100 receives such an MIH capability discover response message and knows which service the RAS 300 supports, it may newly configure a next process and activate a media independent handover or the like.

Meanwhile, the information regarding whether the RAS 300 supports an event service, command service, or information service may respectively include their supportable transport protocol layer information. That is, the information about whether the RAS 300 supports an event service may include information about whether the RAS 300 supports an event service through the layer 2 312 and 314. The information about whether the RAS 300 supports a command service and an information service may include information regarding through which layer the RAS 300 supports command and information services. As a result, the terminal 100 may provide the corresponding service to the RAS 300 through the layer (protocol) that both of the terminal 100 and RAS 300 support for a predetermined service.

The MIH capability discover request message may include whether the terminal 100 supports an event service, whether the terminal 100 supports a command service, and whether the terminal 100 supports an information service. The information regarding whether the terminal 100 supports an event service, command service, or information service may respectively include their supportable transport protocol layer information. The RAS 300 may know a terminal-MIH capability when it receives such an MIH capability discover request message, without transmitting an additional MIH capability discover request message to the terminal 100, and receiving a response thereto. In addition, the RAS 300 may negotiate a service support layer by informing of a preferred layer to the terminal 100, in which the preferred layer is selected from among layers through which the terminal 100 may support a predetermined service.

The service layer selecting unit 142 analyses the MIH capability discover response message received by the capability discover message transmitting/receiving unit 141, grasps whether both of the terminal 100 and the RAS 300 can support a predetermined service, and selects a service layer from among the layers that both the terminal 100 and the RAS 300 can support. Particularly, the service layer selecting unit 142 may select each service layer for the event service, command service, and information service. Hereinafter, service layers for respectively supporting an event service, a command service, and an information service are respectively referred to as an event service transport layer, a command service transport layer, and an information service transport layer. That is, the “event transport layer” is a layer at which the terminal 100 and the RAS 300 support an event service.

The command service processing unit 143 provides the corresponding command to a wireless interface (hereinafter called a wireless interface) formed with a plurality of wireless interfaces when the command received from the MIH user 150 is given as a local command so that the wireless interface performs the corresponding command. The command service processing unit 143 provides the corresponding command through a command service transport layer to the RAS when the command received from the MIH user 150 is given as a remote command so that the RAS 300 performs the corresponding command. When the command service processing unit 143 receives command through the command service transport layer from the RAS 300, it provides the received command to the wireless interface so that the wireless interface performs the corresponding command. Meanwhile, when at least one of the terminal 100 and the RAS 300 may not support a command service, and the command service transport layer of the terminal 100 may not be coincident with at least one of the command service transport layers of the RAS 300, the command service processing unit 143 may not provide remote command to the RAS 300.

The event service processing unit 144 provides the event to the MIH user 150 when the event received from the wireless interface is given as a local event, and accordingly, the MIH user 150 refers to the event. In addition, the event service processing unit 144 provides the event through the event service transport layer to the RAS 300 150 when the event received from the wireless interface is given as a remote event, and accordingly, the RAS 300 refers to the event. Meanwhile, when at least one of the terminal 100 and the RAS 300 may not support an event service, and the event service transport layer of the terminal 100 may not be coincident with at least one of the event service transport layers of the RAS 300, the event service processing unit 144 may not provide remote event to the RAS 300.

The information service processing unit 145 provides a corresponding network information request through the information service transport layer to the RAS 300 when the network information request received from the MIH user 150 is given as a remote request, and accordingly it requests neighbor network information of the RAS 300. The RAS 300 receives the network information request, gathers neighbor network information, and provides the information service processing unit 145 of the terminal 100 through the information service transport layer. The information service processing unit 145 receives the neighbor network information of the RAS 300 and transmits the same to the MIH user 150. Meanwhile, when the information service processing unit 145 receives the network information request from the RAS 300, it gathers network information and transmits the gathered information through the information service transport layer to the RAS 300.

The event subscription list receiving unit 146 receives an event subscription list from the RAS 300. The event subscription list is an event list that the RAS 300 wants to accept. For example, when there are link up, link going down, and link parameter change information events in the event category, and the RAS 300 wants to receive an event corresponding to only the “link going down”, the RAS 300 transmits the event subscription list including “link going down” event to the event subscription list receiving unit 146.

When the event subscription list receiving unit 146 receives an event subscription list, the event service processing unit 144 provides the desired event to the RAS 300 with reference to the event subscription list.

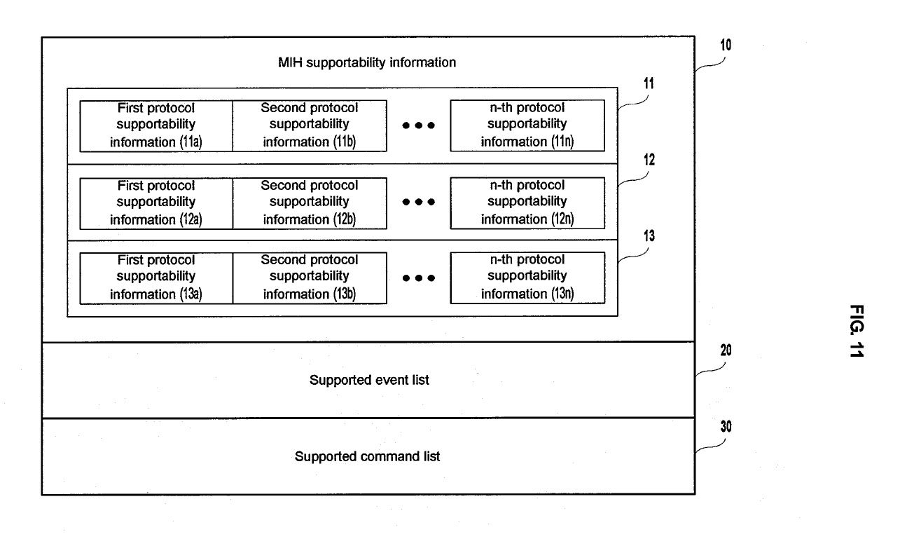

Information included in the MIH capability discover request message or MIH capability discover response message will be described with reference to FIG. 11.

FIG. 11 illustrates MIH capability discover message information according to an exemplary embodiment of the present invention.

As shown in FIG. 11, according to an exemplary embodiment of the present invention, the MIH capability discover message includes MIH supportability information 10 (regarding whether to support MIH), a supported event list 20, and a supported command list 30.

In order to describe information included in an MIH capability discover message according to an exemplary embodiment of the present invention, the MIH capability discover message which the first node transmits to the second node is used as an example.

The MIH supportability information 10 is used when the first node informs the second node whether the first node supports MIH. The MIH supportability information 10 may include event service supportability information 11, command service supportability information 12, and information service supportability information 13.

The event service supportability information 11 is used when the first node informs the second node whether the first node supports event service. For example, when the terminal 100 supports the event service, the terminal 100 receives information that the RAS 300 supports the event service and then transmits the event such as state change information to the RAS 300.

The event service supportability information 11 may include first protocol supportability information 11a and second protocol supportability information 11b. The first protocol supportability information 11a is about whether the terminal 100 can support an event service through the first protocol, and the second protocol supportability information 11b is about whether the terminal 100 can support an event service through the second protocol. The event service supportability information 11 may further include third protocol supportability information 11n as well as the first and second protocols. For example, the first protocol may be a link layer (layer 2) protocol and the second protocol may be a network layer (layer 3) protocol. In addition, the first protocol may be a link layer of the data plane and the second protocol may be a link layer of the management plane.

The first protocol supportability information 11a and the second protocol supportability information 11b may be respectively expressed as 1 bit. All of the first protocol supportability information 11a and the second protocol supportability information 11b may be TRUE or may be FALSE. When all of the first protocol supportability information 11a and the second protocol supportability information 11b are given as FALSE, it means that the terminal 100 does not support an event service.

When the terminal 100 and the RAS 300 support an event service through the first protocol, the terminal 100 may support a local event through the first protocol to the RAS 300, and also the RAS 300 may support a local event through the first protocol to the terminal 100. When the terminal 100 supports an event service through only the first protocol and the RAS 300 support an event service through the second protocol, the terminal 100 and RAS 300 may not provide event service to each other.

The command service supportability information 12 is used when the first node informs the second node whether the first node supports command service. For example, when the terminal 100 supports the command service and receives command service supportability information from the RAS 300, it transmits a command to the RAS 300. The command service supportability information 12 may include first protocol supportability information 12a and second protocol supportability information 12b as the event service supportability information 11. The first protocol supportability information 12a and the second protocol supportability information 12b may be utilized in the same manner as the first protocol supportability information 11a and the second protocol supportability information 11b of the event service supportability information 11. Accordingly, the first protocol supportability information 12a and the second protocol supportability information 12b will not be described in detail.

The information service supportability information 13 is used when the first node informs the second node whether the first node supports information service. For example, when the terminal 100 receives information from the RAS 300 that the RAS 300 supports an information service, the terminal 100 may know neighbor network information by requesting network information to the RAS 300. The information service supportability information 13 may also include first protocol supportability information 13a and second protocol supportability information 13b. The first protocol supportability information 13a and the second protocol supportability information 13b may be utilized in the same manner. Accordingly, the first protocol supportability information 13a and the second protocol supportability information 13b will not be described in detail.

A supported event list 20 is a list of events that the first node can provide to the second node. For example, the terminal 100 may provide the event service supportability information and the supported event list 20 through the first protocol to the RAS 300. At this time, since the RAS 300 may understand which event the terminal 100 can provide through the first protocol, the RAS 300 provides an event subscription list to the terminal 100, in which the event subscription list is an event list that the RAS 300 wants to receive among the supported event list 20. When the terminal 100 receives an event subscription list, it transmits the occurred event through the first protocol to the RAS 300 when the event corresponding to the event subscription list occurs. The supported event list 20 will be described in detail.

The supported command list 30 is a command list that the first node can perform. For example, the terminal 100 may transmit command service supportability information and the supported command list 30 to the RAS 300 through the first protocol. At this time, since the RAS 300 may understand which command the terminal 100 can perform, the RAS 300 provides the corresponding command to the terminal 100, when the terminal 100 is needed to be controlled through a command included in the supported command list 30. Accordingly, the terminal 100 receives a command and performs it.

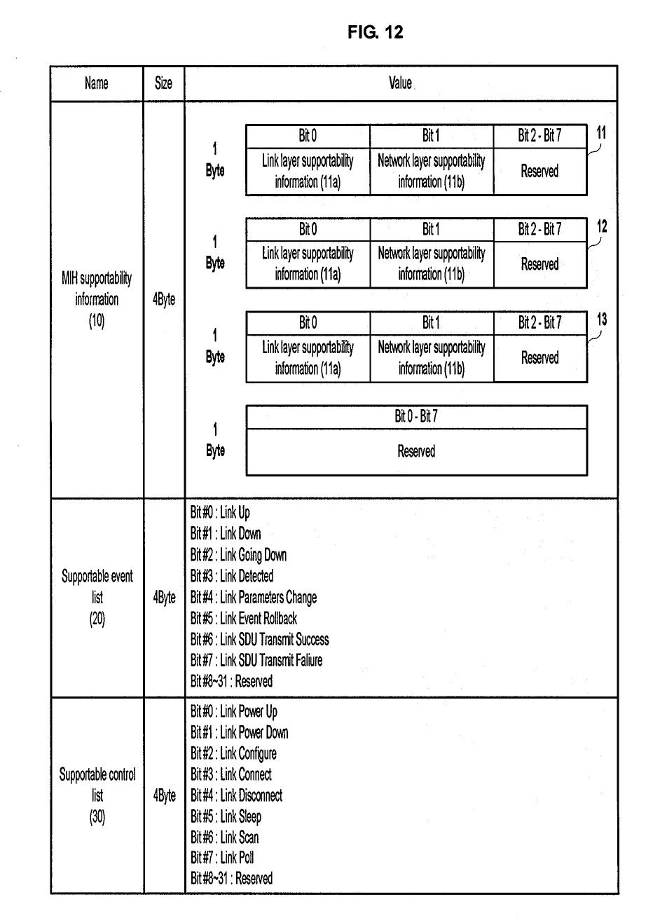

FIG. 12 illustrates a frame format of an MIH capability discover message according to an exemplary embodiment of the present invention.

As shown in FIG. 12, according to an exemplary embodiment of the present invention, the MIH capability discover message has a size of 12 bytes. The MIH capability discover message includes the MIH supportability information 10, the supported event list 20, and the supported command list 30. The MIH supportability information 10, the supported event list 20, and the supported command list 30 respectively have 4 bytes.

The MIH supportability information 10 includes the event service supportability information 11 of 1 byte, the command service supportability information 12 of 1 byte, the information service supportability information 13 of 1 byte, and a dummy area of 1 byte. The event service supportability information 11 includes 1-bit of the link layer supportability information 11a, 1-bit of network layer supportability information 11b, and the rest is dummy area. The link layer supportability information 11a is about whether a node such as the terminal 100 supports an event service through a link layer, and the network layer supportability information 11b is about whether a node such as the terminal 100 supports an event service through a network layer. The command service supportability information 12 includes a 1-bit link layer supportability information 12a, a 1-bit network layer supportability information 12b, and the rest is dummy area. The information service supportability information 13 includes a 1-bit link layer supportability information 13a, 1-bit network layer supportability information 13b, and the rest is dummy area.

Meanwhile, as shown in FIG. 12, the supported event list 20 includes 8 bits, that is, a Link Up supportability information, a Link Down supportability information, a Link Going Down supportability information, a Link Detected supportability information, a Link Parameters Change supportability information, a Link Event Rollback supportability information, a Link SDU Transmit Success supportability information, and Link SDU Transmit Failure supportability information. Each supportability information includes a value of TRUE or FALSE. The Link Up supportability information is about whether the first node informs the second node of an event that the link is connected, the Link Down supportability information is about whether the first node informs the second node of an event that the link is disconnected, the Link Going Down supportability information is about whether the first node informs the second node of an event that the link is about to be disconnected, the Link Detected supportability information is about whether the first node informs an event information of the second node that a new link has been found, the Link Parameters Change supportability information is about whether the first node informs the second node of an event that a link-related parameter is changed, the Link Event Rollback supportability information is about whether the first node informs the second node of an event that the being disconnected link is again connected, the Link SDU Transmit Success supportability information is about whether the first node informs the second node of an event that an SDU (Service Data Unit) is successfully transmitted, and the Link SDU Transmit Failure supportability information is about whether the first node informs the second node of an event that a SDU (Service Data Unit) is not successfully transmitted.

As shown in FIG. 12, the supported command list 30 includes 8 bits, that is, a Link Power Up supportability information, a Link Power Down supportability information, a Link Configure supportability information, a Link Connect supportability information, a Link Disconnect supportability information, a Link Sleep supportability information, a Link Scan supportability information, and a Link Poll supportability information. Each supportability information has a value of TRUE or FALSE. The Link Power Up supportability information is about whether the first node receives a Link Power Up command from the second node and turns on a link-related power, the Link Power Down supportability information is about whether the first node receives a Link-Power Down command from the second node and turns off a link-related power, the Link Configure supportability information is about whether the first node receives a Link Configure command from the second node and changes the link-related parameters through parameter information included in the command, the Link Connect supportability information is about whether the first node receives a Link Connect command from the second node and can connect a link, the Link Disconnect supportability information is about whether the first node receives a Link Disconnect command from the second node and can disconnect a link, the Link Sleep supportability information is about whether the first node receives a Link Sleep command from the second node and converts a state into a sleep state, the Link Scan supportability information is about whether the first node receives a Link Scan command from the second node and the first node can search a connectable link, and the Link Poll supportability information is about whether the first node receives a Link Poll command from the second node and the first node can understand a neighbor link state.

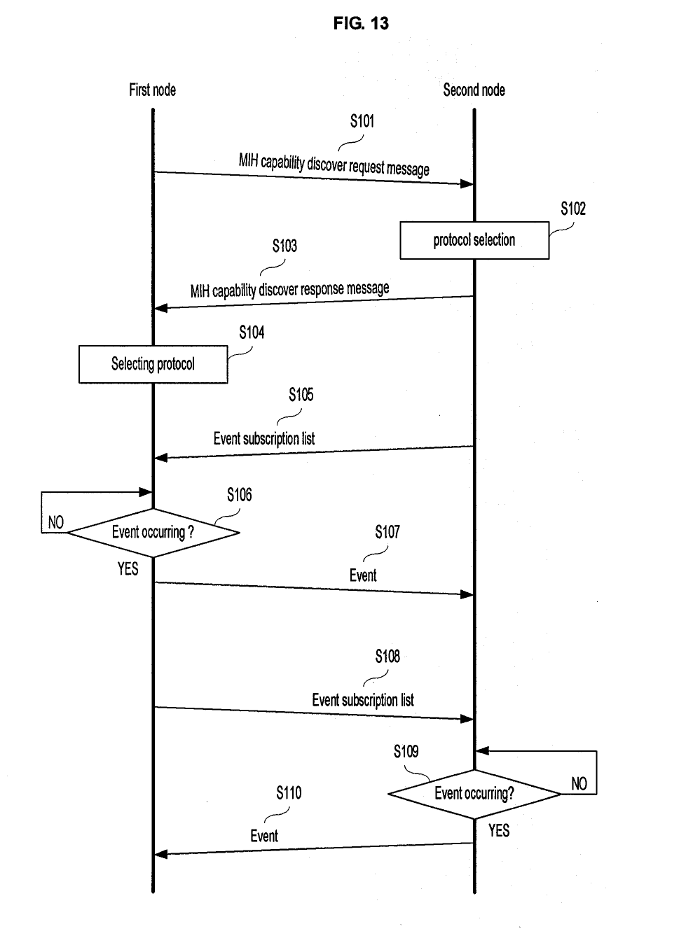

Now, how to exchange an MIH between the first and second nodes is described with reference to FIG. 13 to FIG. 15.

FIG. 13 is a flowchart for exchanging an event service between first and second nodes according to an exemplary embodiment of the present invention.

First, the first node transmits an MIH capability discover request message to the second node (S101).

The second node may understand a first node's MIH capability information through the MIH capability discover request message. When the first node supports an event service through a plurality of layers, the second node may select a part of the entirety of a plurality of layers as an event service transport layer (S102). The second node transmits an MIH capability discover response message in response to the MIH capability discover request message to the first node (S103). At this time, the second node may not provide the MIH capability discover response message in response to the MIH capability discover request message to the first node, but may provide the MIH capability discover response message by means of the broadcasting. Particularly, when the second node selects a part of an entirety of a plurality of layers included in the MIH capability discover request message as an event service transport layer, the second node transmits MIH capability discover response message including the information about selected event service transport layers to the first node. Since the MIH capability discover request message and the MIH capability discover response message respectively include the MIH capability information of the first and second nodes, the first and second nodes may understand cross-capability information by exchanging information at once.

When the MIH capability discover response message includes the link layer supportability information 11a and the network layer supportability information 11b, the first node selects which is used among the link and network layers as an event service transport layer (S104). For example, if the second node can support an event service only through a link layer and also the first node can support an event service only through a link layer, the first node selects a link layer as an event service transport layer. Alternatively, if the second node can support an event service only through a network layer and also the first node can support an event service only through a network layer, the first node selects a link layer as an event service transport layer.

Meanwhile, the second node may provide an event subscription list to the first node, which is about the events it wants to receive (S105). Particularly, when the MIH capability discover request message includes a supported event list, the second node may provide a desired event subscription list among events included in the supported event list to the first node.

When the second node informs the first node that the event service is supported through the MIH capability discover response message, the first node provides the occurred event to the second node (S106, S107). Particularly, when the MIH capability discover response message includes the link layer supportability information 11a and network layer supportability information 11b, and accordingly the first node selects an event service transport layer, the first node provides the occurred event through the selected layer (event service transport layer) to the second node. When the first node accepts the event subscription list from the second node, the first node may provide the event to the second node only when the occurred event is included in the event subscription list.

Meanwhile, the first node may occasionally provide an event subscription list to the second node (S108). Particularly, when the MIH capability discover response message includes the supported event list of the second node, the first node may provide the desired events among events included in the supported event list to the second node.

When the first node informs the second node through the MIH capability discover request message that the event service is supported, the second node provides the occurred event information to the first node (S109, S110). Particularly, when the second node receives event service transport layer information from the first node, the second node may provide the occurred event through the event service transport layer to the first node. When the second node accepts an event subscription list from the first node, the second node may provide an event to the first node only if the occurred event is included in the event subscription list.

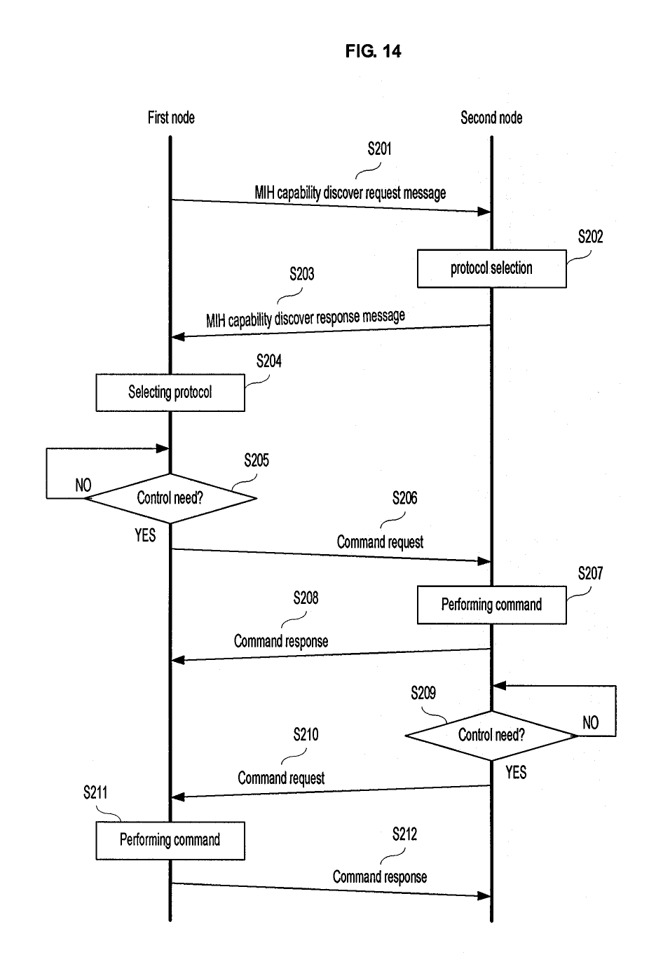

FIG. 14 is a flowchart for exchanging a command service between first and second nodes according to an exemplary embodiment of the present invention.

Steps S201 to S204 corresponding to the steps S101 to S104 of FIG. 13 will not be described.

When the second node informs the first node through the MIH capability discover response message that the command service is supported and the first node determines the second node to be controlled (S205), the first node transmits a command to the second node (S206). Particularly, when the first node selects a command service transport layer since the MIH capability discover response message includes the link layer supportability information 12a and the network layer supportability information 12b, the first node provides a command through the selected layer (command service transport layer) to the second node. When the first node receives the supported command list from the second node, the first node provides a command to the second node only if the command is included in the supported command list 30.

The second node having received a command performs the command (S207), and informs the first node of the command response(S208). Particularly, when the second node receives the command service transport layer from the first node (S204), the second node may inform the first node of the command response through the received command service transport layer.

Since steps S209 to S212 may be easily obtained from the steps S205 to S208, description thereof will be omitted.

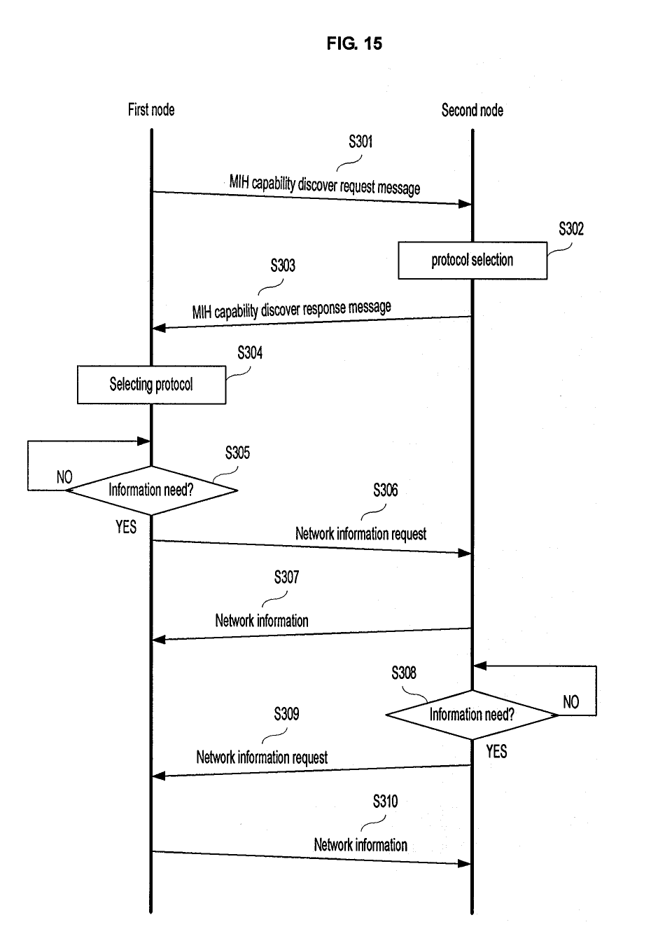

FIG. 15 is a flowchart for exchanging an information service between first and second nodes according to an exemplary embodiment of the present invention.

Since the steps S301 to S304 correspond to the steps S101 to S104 of FIG. 13, a description thereof will be omitted.

When the second node informs the first node through the MIH capability discover response message that information service is supported, the first node is determined to need neighbor network information of the second node (S305), and the first node requests network information to the second node (S306). Particularly, when the first node selects information service transport layer because the MIH capability discover response message includes the link layer supportability information 13a and network layer supportability information 13b, the first node requests network information through the selected layer (information service transport layer) to the second node.

The second node having been requested a network information provides network information to the first node (S307). Particularly, the second node receives an information service transport layer from the first node (S304) and the second node provides network information to the corresponding layer.

Since the steps S309 to S312 may be obtained from the steps S305 to S308, a description thereof will be omitted.

The recording medium may include all types of recording media that a computer can read, for example an HDD, a memory, a CD-ROM, a magnetic tape, and a floppy disk, and it may also be realized in a carrier wave (e.g., Internet communication) format.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to an exemplary embodiment of the present invention, a node performing a media independent handover may more clearly understand an MIH capability of other handover-related nodes, and accordingly, may effectively perform the handover.

What is claimed is:

1. A service providing method for a first node to provide a service to a second node, the service providing method comprising:
receiving a first message from the second node, the first message including information about whether the second node supports a service through a first layer and whether the second node supports a service through the second layer;
selecting a service transport layer for providing a service from the first and second layers; and
providing a service to the second node through the service transport layer.

2. The service providing method of claim 1, wherein the providing a service includes providing the event to the second node through the service transport layer, the event being about an occurred state variance of the first node called an event.

3. The service providing method of claim 1, further comprising receiving an event subscription list from the second node,
wherein the providing a service includes providing the occurred event to the second node through the service transport layer when the event corresponding to an occurred state variance of the first node called an event is included in the event subscription list.

4. The service providing method of claim 1, wherein the providing a service includes providing the command to the second node through the service transport layer.

5. The service providing method of claim 1, wherein the first message further includes a supported command list, and the providing a service includes proving a command through the service transport layer when the command for the second node is included in the supported command list.

6. The service providing method of claim 1, wherein the providing a service includes requesting network information from the second node through the service transport layer .

7. The service providing method of claim 1, wherein the providing a service includes providing network information to the second node through the service transport layer when the first node receives a network information request from the second node.

8. The service providing method of claim 1, further comprising transmitting a second message to the second node, the second message including information about whether the first node supports the service through the first layer and whether the first node supports the service through the second layer.

9. The service providing method of claim 8, further comprising receiving an event subscription list from the second node, the event subscription list regarding events that the second node wants to receive among a supported event list, wherein the second message further comprises the supported event list that the first node provides to the second node, and the providing a service includes providing the event through the service transport layer to the second node when an event, that is, a state variance of the first node, occurs and is included in the event subscription list.

10. A service providing method for a first node providing a service to a second node, the service providing method comprising:
receiving a first message from the second node, the first message including first, second, and third information respectively concerning whether the second node supports a command service, whether the second node supports an event service, and an information service;
providing a command to the second node when the second node supports the command service;
providing an event to the second node when the second node supports the event service, the event being state variance information of the first node; and
providing the information to the second node when the second node supports the information service.

11. The service providing method of claim 10, wherein
the third information includes information about whether the second node supports the information service through the first protocol and whether the second node supports the information service through the second protocol, and
the providing of the information service includes the second node providing the information service through one of the first and second protocols that supports the information service.

12. The service providing method of claim 10, wherein
the first information includes information about whether the second node supports the command service through the first protocol and whether the second node supports the command service through the second protocol, and
the providing the command includes the second node providing the command through one of the first and second protocols that supports the command service.

13. The service providing method of claim 10, wherein
the second information includes information about whether the second node supports the event service through the first protocol and whether the second node supports the event service through the second protocol, and
the providing of the event includes providing the event through one of the first and second protocols that supports the event service.

14. The service providing method of claim 10, wherein
the first message further includes a supported command list that the second node can perform, and
the providing a command to the second node includes providing the command to the second node when the command for the second node is included in the supported command list.

15. The service providing method of claim 10, further comprising providing a second message to the second node, the second message including information about whether the first node supports a command service, whether the first node supports an event service, and whether the first node supports an information service.

16. The service providing method of claim 15, wherein
the second message further includes a supported event list that the first node can provide to the second node,
the service providing method further comprises receiving the event subscription list from the second node, the event subscription list being what the second node wants to receive among the supported event list,
and the providing of the event includes providing the event to the second node when the event is included in the event subscription list.

17. A service providing apparatus for providing a service to a first node, the service providing apparatus comprising:
a wireless interface unit including at least one wireless interface and providing a wireless data service;
an application unit for using the wireless data service;
a message transmitting/receiving unit for receiving a first message from the first node, the first message including first, second, and third information respectively concerning whether the first node supports a command service, whether the first node supports an event service, and whether the first node supports an information service;
a command service processing unit for providing a command of the application unit to the first node when the first node supports the command service;
an event service processing unit for providing an event to the first node when the first node supports the event service, the event regarding state variance information of the wireless interface; and
an information service processing unit for providing network information to the first node in response to a network information request from the first node when the first node supports the information service.

18. The service providing apparatus of claim 17, wherein
the third information includes information about whether the first node supports the information service through the first protocol and whether the first node supports the information service through the second protocol,
the service providing apparatus further comprises a protocol selecting unit for selecting an information service protocol for supporting an information service from among the first and second protocols, and
the information service processing unit provides the network information through the information service protocol.

19. The service providing apparatus of claim 17, wherein
the first information includes information about whether the first node supports the command service through the first protocol and whether the first node supports the command service through the second protocol,
the service providing apparatus further comprises a protocol selecting unit for selecting a command service protocol for supporting the command service from among the first and second protocols, and
the command service processing unit provides the command through the command service protocol.

20. The service providing apparatus of claim 17, wherein the third information includes information about whether the first node supports the event service through the first protocol and whether the first node supports the event service through the second protocol,
the service providing apparatus further comprises a protocol selecting unit for selecting an event service protocol for supporting an event service from among the first and second protocols, and
the event service processing unit provides the event through the event service protocol.

21. The service providing apparatus of claim 17, wherein
the first message further includes a supported command list that the first node can perform, and
the command service processing unit provides the command through the first node when the command is included in the supported command list.

22. The service providing apparatus of claim 17, wherein
the message transmitting/receiving unit provides a second message to the first node, the second message including information about whether the command service is supported, whether the event service is supported, and whether the information service is supported.

23. The service providing apparatus of claim 22, wherein
the second message further includes a supported event list that the first node can provide,
the service providing apparatus further comprising an event subscription list receiving unit for receiving an event subscription list from the first node, the event subscription list being what the second node wants to receive among the supported event list, and
the event service processing unit provides the event to the first node when the event is included in the event subscription list.
